(19) United States
(12) Patent Application Publication
(10) Pub. No.: US 2022/0252118 A1
(43) Pub. Date: Aug. 11, 2022

(54) Brake Dust Particle Filter Assembly, Disc Brake Assembly Comprising a Brake Dust Particle Filter Assembly, and Vehicle Comprising a Disc Brake Assembly

(71) Applicant: MANN+HUMMEL GmbH, Ludwingsburg (DE)

(72) Inventors: Lukas Bock, Bietigheim-Bissingen (DE); Thomas Jessberger, Asperg (DE); Volker Kummerling, Bietigheim-Bissingen (DE); Coskun Evlekli, Waiblingen (DE); Jan Corba, Chamerau (DE); Benedikt Weller, Steinheim (DE)

(21) Appl. No.: 17/727,002

(22) Filed: Apr. 22, 2022

Related U.S. Application Data
(63) Continuation of application No. PCT/EP2020/079601, filed on Oct. 21, 2020.

(51) Int. Cl. F16D 65/00; F16D 55/22

(52) U.S. Cl. CPC F16D 65/0031; F16D 55/22

(57) ABSTRACT

A brake dust particle filter assembly has a brake dust particle filter with a ring segment-shaped housing receiving a brake disc of the disc brake assembly. The housing has two axially spaced apart housing sidewalls and a housing circumferential wall between the housing sidewalls. A filter element is arranged in the housing. A holding component that holds the brake dust particle filter in installed position is stationary relative to the disc brake assembly. Holding component and housing are fixed to each other directly by mutual engagement in the installed position, at least in relation to an angular position and/or a radial position of holding component and housing relative to each other. The mutual engagement is by form fit of a male connection geometry with a corresponding female connection geometry. The male connection geometry is provided at the holding component and the female connection geometry at the housing, or vice versa.

### CROSS-REFERENCE TO RELATED APPLICATIONS

This application is a continuation application of international application No. PCT/EP2020/079601 having an international filing date of 21 Oct. 2020 and designating the United States, the international application claiming a priority date of 22 Oct. 2019 based on prior filed German patent application No. 10 2019 128 470.8, the entire contents of the aforesaid international application and the aforesaid German patent application being incorporated herein by reference.

### BACKGROUND OF THE INVENTION

The invention relates to a brake dust particle filter assembly for catching brake dust particles produced upon actuation of a disc brake assembly, with a brake dust particle filter that comprises a ring segment-shaped housing for at least partially receiving a brake disc of the disc brake assembly, wherein the housing comprises two housing sidewalls that are axially spaced apart from each other and a circumferential wall extending in circumferential direction between the housing sidewalls, and with at least one filter element arranged in the housing, and with a holding component that is configured to hold the brake dust particle filter in an installed position that is stationary relative to the disc brake assembly.

Moreover, the invention relates to a disc brake assembly with a brake disc, a brake caliper, and such a brake dust particle filter assembly as well as to a vehicle with such a disc brake assembly.

Upon actuation of a disc brake assembly, brake dust particles are generated. They are produced by brake abrasion due to friction between a brake pad of the disc brake assembly and a brake disc of the disc brake assembly. If possible, these brake dust particles should not escape into the environment of the disc brake assembly because they produce a fine particulate matter pollution of the ambient air. This fine particulate matter pollution is damaging to the environment and to human beings. It is to be avoided. For this purpose, it is known to provide a brake dust particle filter assembly of the aforementioned kind. The housing in which the filter element is arranged at least partially accommodates the brake disc of the disc brake assembly. In this way, brake dust particles that are produced by brake abrasion at the brake disc can be taken up directly in the housing. Here, they impact on the filter element and are separated in the filter element.

Such a brake dust particle filter assembly is suitable for arbitrary applications of disc brake assemblies. It can be provided for mobile as well as stationary applications. Mobile applications can be vehicles, for example, passenger cars, trucks, buses, and rail vehicles. A stationary application can be, for example, the shaft brake of a wind power station.

The brake dust particle filter must be held in the stationary installed position relative to the disc brake assembly in every operating state thereof. On the one hand, this enables the efficient take-up of the brake dust particles generated in the disc brake assembly. On the other hand, it is to be avoided thereby that a possibly existing movement clearance (play) in the location of the brake dust particle filter relative to the disc brake assembly negatively affects the smooth running of the disc brake assembly in operation. Such a movement clearance would abet wear of the components of the brake dust particle filter and possibly of the disc brake assembly and reduce their service life. The movement clearance of the brake dust particle filter relative to the disc brake assembly can occur in principle in three (orthogonal) dimensions in the installed position: On the one hand, in the axial direction (the direction of the axis of rotation of the brake disc), on the other hand, in the circumferential direction (the direction of rotation of the brake disc), and finally in the radial direction (the direction of radial extension of the brake disc).

On the other hand, the brake dust particle filter also constitutes a service component of the brake dust particle filter assembly. The brake dust particle filter or the filter element must be exchanged, renewed or regenerated after a certain time period. This requires the (at least partial) removal of the brake dust particle filter from the brake dust particle filter assembly. However, the installation space which is provided, for example, in particular in automotive applications of the brake dust particle filter assembly, is typically very limited. Therefore, during installation/removal, canting of the brake dust particle filter with surrounding components may easily happen due to uncontrolled movements of the brake dust particle filter (for example, due to carelessness of the service technician). A limitation of the movement clearance of the brake dust particle filter is therefore also advantageous for reasons of “guidance” of the brake dust particle filter in the existing installation space during installation/removal from the brake dust particle filter assembly.

### SUMMARY OF THE INVENTION

It is therefore the object of the invention to provide a brake dust particle filter assembly that reduces the movement clearance between the brake dust particle filter and the disc brake assembly at least in the circumferential direction and the radial direction and enables mounting/demounting as easily as possible and substantially without tool.

This object is solved in that the holding component and the housing can be directly fixed relative to each other, at least in relation to their angular position in circumferential direction and/or their radial position, by a mutual engagement in the installed position.

The holding component will preferably be fastened in the installed position at a component of the disc brake assembly. It can be fastened thereat, for example, in a releasable manner. This attachment can be realized, for example, by screwing. Upon installation of the brake dust particle filter in the disc brake assembly, the brake dust particle filter is then brought into engagement with the holding component that is already fastened at the disc brake assembly. This engagement in the installed position immobilizes the housing relative to the holding part in the installed position at least partially: The holding component and the housing are fixed relative to each other in relation to their angular position in circumferential direction and/or their radial position in the stationary installed position. Accordingly, one and/or two degrees of freedom (circumferential direction, radial direction) of the movement clearance can be reduced or even eliminated. Also, this can be done in a particularly simple and easily realizable manner: The holding component and the housing can be fixed immediately by mutual engagement in the stationary installed position. Thus, indirect fastening or fixing means, for example, screws, can be mostly dispensed with. Mounting and demounting of holding component and housing relative to each other can thus be realized simply by producing and releasing the mutual engagement. The use of additional tools can be dispensed with. The direct mutual engagement of holding component and housing is realized advantageously already at the beginning of mounting of the brake dust particle filter. In this way, a “guidance” of the housing relative to the holding component results upon transfer of the brake dust particle filter into the installed position. As soon as the mutual engagement between the holding component and the housing is thus produced, both elements are immobilized relative to each other in their angular position in circumferential direction and/or their radial position. As soon as the brake dust particle filter is located in the stationary installed position, it can be advantageously additionally fixed in its position by an indirect connection, for example, by means of screwing, at the holding component.

The mutual engagement is realized by means of a form-fit engagement of at least one male connection geometry with at least one corresponding female connection geometry, wherein the male connection geometry is present at the holding component and the female connection geometry at the housing, or vice versa.

The male connection geometry can be present at the holding component and the female connection geometry at the housing. Alternatively, the male connection geometry can be present at the housing and the female connection geometry at the holding component. The male connection geometry and/or the female connection geometry can be embodied respectively as one piece together with the holding component or the housing. In this case, they can be directly manufactured jointly while manufacturing holding component and housing. However, the male connection geometry and/or the female connection geometry can be present also advantageously as additional components. In this case, they can be simply retrofitted, as needed, at existing brake dust particle filters. The male connection geometry comprises at least one male connection section. The female connection geometry comprises at least one female connection section. The male connection section is configured to produce with the female connection section a mechanical connection by means of “interlocking”. This connection forms then preferably the form-fit mutual engagement of the male connection geometry with the female connection geometry. The mutual engagement can be produced in a constructively simple manner.

Due to male and female connection geometries at brake dust particle filter and holding component that are matched to each other, an unequal correlation of a predetermined pair of brake dust particle filter and holder can be ensured so as to fit a certain disc brake assembly. This unequivocal correlation can be realized by variations of the sizes and/or shape of the respective male and female connection geometries for each pair.

In this way, faulty installation of brake dust particle filters that do not fit can be avoided, which could have severe consequences because there is the imminent danger of a collision with moving parts, for example, in case of mounting of a brake dust particle filter that is not suitable in regard to circumference and/or radius for a respective disc brake assembly.

Further embodiments of the invention are indicated in the respective dependent claims.

Also, it is advantageous that the male connection geometry or the female connection geometry is present at least at one of the housing sidewalls, preferably wherein the male connection geometry or the female connection geometry extends at least in axial direction from the housing sidewall on a side of the housing sidewall which is facing away from the filter element.

The housing sidewalls of the housing of a brake dust particle filter represent a component that (in certain predetermined limits of the existing installation space) can be modified in its shape without the functionality of the brake dust particle filter being negatively affected in this context. Therefore, at and/or in the housing sidewalls, an additional structure, such as the male connection geometry or the female connection geometry, can be particularly advantageously present. In this context, the filter element, at least partially the brake disc, and optionally further elements are accommodated in the interior of the housing. The installation space within the housing is thus typically limited due to systemic causes. It is therefore advantageous to provide the male connection geometry or the female connection geometry at a side of the housing sidewall which is facing away from the filter element. In other words, the male connection geometry or the female connection geometry is advantageously provided on an axially outwardly positioned side of the housing. In this context, the male connection geometry (or the male connection section) or the female connection geometry (or the female connection section) will extend also in axial direction. In this way, an axial component of the mutual engagement of male connection geometry and female connection geometry is provided. Such an axial component can fix at least the relative angular position of holding component and housing relative to each other in circumferential direction and thus reduce or eliminate a degree of freedom of the movement clearance.

It is preferred that the female connection geometry comprises at least one groove with a groove base extending in radial direction and two groove flanks oppositely positioned in circumferential direction, preferably wherein the groove flanks are designed to gradually rise away from the groove base in circumferential direction.

The groove forms in this case the female connection section of the female connection geometry. The “height difference” between the groove base and the surface of the remainder of the component (holding component or housing) forms the extension of the female connection geometry in the axial direction. The groove base extends at least in radial direction. The groove flanks form therefore a limitation of the groove base in circumferential direction. The groove flanks are not formed in this context as a (rectangular) “stepped profile” but are present advantageously with a “curved profile”. A gradual transition from the groove base to the surface of the remainder of the component (holding component or housing) is provided. The engagement of the male connection geometry (or of the male connection section) with the female connection geometry (or the female connection section—here: the groove) with each other reduces thus the movement clearance of holding component and housing relative to each other. The gradual configuration of the groove flanks enables an advantageous distribution of the forces occurring in this context. Bringing into engagement male connection geometry and female connection geometry is facilitated here also.

It is also advantageous that the groove is closed at a groove inner end face facing inwardly in radial direction, which is preferably embodied in the female connection geometry, wherein an outer end face facing outwardly in radial direction of the male connection geometry contacts the groove inner end face in the installed position.

The groove is present in the component (holding component or housing) in closed form, i.e., not continuous. The closure of the groove provides a stop for the corresponding male connection part in radial direction. The closure of the groove can be realized by means of a corresponding configuration of the groove in the component (holding component or housing). This can be realized particularly easily during manufacture. On the other hand, a corresponding closure component can also be provided with which the groove is closed. For example, this can be a housing circumferential wall. The closure of the groove forms accordingly a groove inner end face at its closed end. The latter is positioned at a side of the closed end which is facing the groove base. In other words, the groove inner end face faces inwardly in radial direction. The male connection geometry (or the male connection section) comprises an outer end face which corresponds to the groove inner end face. It is oriented outwardly in the radial direction. It is therefore arranged opposite to the groove inner end face in the installed position. The outer end face of the male connection geometry contacts the groove inner end face in the stationary installed position. In this way, a movement clearance of the holding component relative to the housing is reduced or prevented in the radial direction at least radially outwardly.

It is also preferred that the groove base comprises a locking element that is outwardly projecting in axial direction and that, in the installed position, is locked with an inner end face of the male connection geometry that is facing inwardly in radial direction.

The inner end face of the male connection geometry (or of the male connection section) which is facing radially inwardly in a radial direction can be arranged opposite to the outer end face of the male connection geometry that is facing outwardly in the radial direction. In the installed position, this inner end face of the male connection geometry then “engages from behind” at least partially the locking element. Accordingly, the inner end face of the male connection geometry locks then with the locking element of the female connection geometry. Male connection geometry and female connection geometry are in mutual engagement. The closure of the groove, on the one hand, reduces or prevents the movement clearance of the holding component relative to the housing in the radial direction at least radially outwardly. The locking element, on the other hand, reduces or prevents the movement clearance of the holding component relative to the housing in the radial direction at least radially inwardly.

Moreover, it is advantageous that the female connection geometry comprises at least one locking element which is projecting across the groove base and that, in the installed position, engages a plug section of the male connection element which is arranged in the groove or engages across or from behind the plug section. Preferably, the locking element is embodied as an extension of a housing sidewall of the brake dust particle filter which extends across the groove base.

The locking element can be present advantageously at a groove flank. Also, at each one of the two groove flanks at least one locking element can be present, respectively. The plug section of the male connection geometry forms the male connection section of the male connection geometry which is in engagement with the female connection section of the female connection geometry in the installed position. In this context, the groove and the plug section will preferably be in engagement with form fit in the installed position. Groove and plug section can have a “dovetail profile”. The engagement of the locking element with the plug section can be embodied in various way. On the one hand, in the plug section at least one receiving slot extending in radial direction can be provided in which the locking element in the installed position is received. Receiving of the locking element in the receiving slot is preferably embodied with form fit. The locking element is correspondingly locked. On the other hand, the plug section can be received in the installed position in the groove such that it “engages from behind” the locking element outwardly in the axial direction. A movement of the plug section outwardly in the axial direction is then prevented or reduced. The functional interaction of the locking element and of the plug section enables in this context a securing of the axial position of the brake dust particle filter in relation to the holding component.

It is even more preferred that the mutual engagement can be produced by means of at least one ring segment geometry of the male connection geometry that projects in axial direction and extends in circumferential direction and that is in engagement, preferably with form fit, with a corresponding ring segment receptacle of the female connection geometry in the installed position.

The ring segment geometry provides an alternative or additional configuration of the male connection section. The ring segment receptacle provides correspondingly an alternative or additional configuration of the female connection section. The projection of the ring segment geometry in axial direction reduces or prevents in this embodiment the movement clearance of the holding component relative to the housing in the radial direction. The extension of the ring segment geometry in circumferential direction reduces or prevents the movement clearance of the holding component relative to the housing in the circumferential direction.

Not least, it is advantageous that the ring segment receptacle by means of a ring segment-shaped section of a radially inwardly facing inner end face of the female connection geometry is configured such that the holding component and the housing can be moved relative to each other in circumferential direction in the installed position.

The holding component and the housing are in fact stationarily fixed relative to each other in their radial position in the installed position but not in their angular position in circumferential direction. Therefore, a “post correction” of the angular position of the holding component relative to the housing in the installed position remains initially possible. The brake dust particle filter can thus be rotated finally into its installed position. In this installed position, it is then fixed stationarily, for example, by means of screws.

Moreover, it can be advantageously provided that a circumferential extension of the male connection geometry and the female connection geometry in radial direction is variable, wherein in particular the circumferential extension of the male connection geometry and of the female connection geometry decreases in an outwardly oriented direction. In this way, a particularly good and in particular clearance-free relative positioning of the brake dust particle filter and of the holding component can be enabled. This further embodiment of the invention is suitable for the embodiment of the female connection geometry as groove as well as for the embodiment of the female connection geometry as ring segment receptacle. Preferably, the groove or the ring segment receptacle can taper radially outwardly so that a pointed or conical profile in radial direction results.

The invention concerns moreover a disc brake assembly with a brake disc, a brake caliper, and a brake dust particle filter assembly as described above. Such a disc brake assembly comprises the advantages associated with the brake dust particle filter assembly according to the invention.

The invention concerns finally a vehicle with such a disc brake assembly, wherein the holding component is stationarily fixed at a vehicle component of the vehicle, in particular at a steering knuckle, preferably at a brake caliper holder, in relation to a brake caliper of the disc brake assembly.

### BRIEF DESCRIPTION OF THE DRAWINGS

Further advantages result from the following drawing description. In the drawings, embodiments of the invention are illustrated. The drawings, description, and claims contain numerous features in combination. A person of skill in the art will consider the features expediently also individually and combine them to expedient further combinations. The Figures show embodiments in an exemplary fashion.

FIG. 1a shows a first embodiment of the brake dust particle filter assembly in a disc brake assembly, wherein a brake dust particle filter is not in an installed position.

FIG. 1b shows the first embodiment of the brake dust particle filter assembly in the disc brake assembly, wherein the brake dust particle filter is in the installed position.

FIG. 2a shows a holding component and a housing of a brake dust particle filter according to a second embodiment of the invention, wherein the holding component and the housing are not in the installed position.

FIG. 2b shows the holding component and the housing of the brake dust particle filter according to the second embodiment of the invention, wherein the holding component and the housing are in the installed position.

FIG. 3a shows a holding component and a housing of a brake dust particle filter according to a third embodiment of the invention, wherein the holding component and the housing are not in the installed position.

FIG. 3b shows the third embodiment of the brake dust particle filter assembly in a disc brake assembly, wherein a brake dust particle filter is in the installed position.

FIG. 4a shows a holding component and a housing of a brake dust particle filter according to a fourth embodiment of the invention, wherein the holding component and the housing are not in the installed position.

FIG. 4b shows the holding component and the housing of the brake dust particle filter according to the fourth embodiment of the invention, wherein the holding component and the housing are in the installed position.

### DESCRIPTION OF PREFERRED EMBODIMENTS

The Figures show only examples and are not to be understood as limiting.

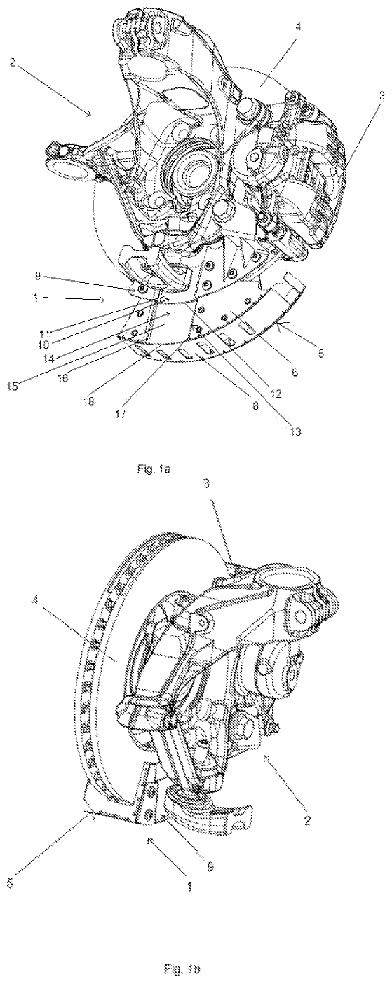

FIG. 1a shows a brake dust particle filter assembly 1 in a disc brake assembly 2. The disc brake assembly 2 comprises a brake caliper 3 and a brake disc 4. The brake dust particle filter assembly 1 comprises a ring segment-shaped housing 5 with a first housing sidewall 6 and a second housing sidewall 7. The first housing sidewall 6 and the second housing sidewall 7 extend in a circumferential direction and are axially spaced apart. Between them, a housing circumferential wall 8 extends in circumferential direction. The ring segment-shaped housing 5 accommodates the brake disc 4 at least partially. In it, a filter element (not illustrated) is arranged. Furthermore, the brake dust particle filter assembly 1 comprises a holding component 9 that is fastened to the disc brake assembly 2.

The holding component 9 comprises a male connection geometry 10 that presently comprises a plug section 11. The plug section 11 comprises an outer end face 12 that is facing outwardly in radial direction. A corresponding female connection geometry 13 is present in the first housing sidewall 6. The female connection geometry 13 comprises a groove 14 as a female connection section. The groove 14, in turn, comprises a groove base 15 and a first groove flank 16 and a second groove flank 17. The groove 14 is closed in the first housing sidewall 6 at a groove inner end face 18 that is inwardly facing in radial direction. Closure of the groove 14 is realized presently by means of the housing circumferential wall 8. In this first embodiment, it can be seen also that the first groove flank 16 and the second groove flank 17 are embodied to rise gradually from the groove base 15.

In FIG. 1a, the brake dust particle filter assembly 1 is shown during mounting. The housing 5 is brought into engagement with the holding part 9. In a stationary installed position, the holding component 9 then holds the brake dust particle filter or the housing 5 in a fixed position relative to the disc brake assembly 2. This installed position is illustrated in FIG. 1b.

For such a mounting of the brake dust particle filter or of the housing 5 at the holding component 9 or the disc brake assembly 2, the movement clearance of the housing 5 relative to the holding component 9 should be kept minimal. This is expedient, on the one hand, because, for example, in automotive applications typically only a very limited installation space is available. In it, a movement of the brake dust particle filter or of the housing 5 during mounting should be avoided, if possible, in order to prevent canting thereof in the installation space at other components. However, it is expedient, on the other hand, to also reduce the movement clearance in the installed position in order to prevent signs of wear of the components. This is achieved by the mutual engagement of the male connection geometry 10 and the female connection geometry 13. This is produced by the engagement of the plug section 11 with the groove 14. At the beginning of mounting, this engagement can provide a “guidance” of the housing 5 along the holding component 9 in the direction toward the installed position. The engagement of the plug section 11 with the groove 14 fixes the holding component 9 relative to housing 5 in their angular position to each other in circumferential direction. In the installed position, the outer end face 12 of the holding component 9 which is facing in radial direction outwardly is also contacting the groove inner end face 18 that is facing inwardly in radial direction. In this way, the holding component 9 is fixed relative to the housing 5 in the radial position. The movement clearance of holding component 9 relative to the housing 5 is reduced or eliminated in two degrees of freedom. A movement clearance in the axial direction is also reduced or eliminated by the mutual engagement of the plug section 11 and the groove 14.

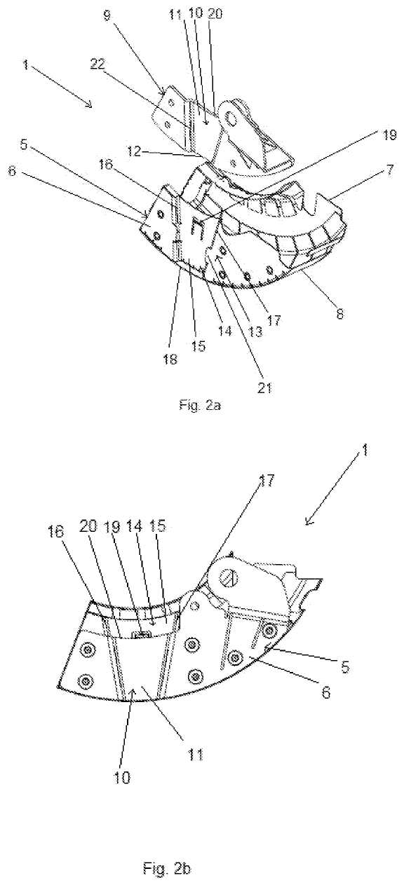

FIG. 2a shows a second embodiment of the brake dust particle filter assembly 1 in which the holding component 9 and the housing 5 are not in the installed position. The installed position is illustrated in FIG. 2b. The function of the features of the brake dust particle filter assembly 1 according to the invention that have been described so far is identical here to that of FIGS. 1a and 1b.

In addition, the brake dust particle filter assembly 1 here comprises in FIGS. 2a and 2b a locking element 19 projecting in axial direction. In the installed position of the brake dust particle filter assembly 1, this locking element 19 is locked with an inner end face 20 facing inwardly in radial direction. A fixation of the holding component 9 relative to the housing 5 is achieved that reduces or prevents a movement clearance in a radial direction inwardly. This supplements the prevention or reduction of the movement clearance of the holding component 9 relative to the housing 5 outwardly in the radial direction by means of the contact of the groove inner end face 18 facing inwardly in radial direction at the outer end face 12 of the plug section 11 facing outwardly in radial direction.

Moreover, in FIG. 2a also a locking element 21 present at the female connection geometry 13 is shown. The locking element 21 projects across the groove base 15. The locking element 21 is received in the installed position with form fit in a receiving slot 22 of the male connection geometry 10 (here illustrated for clarity of the illustration at the side of the male connection geometry 10 opposite the locking element 21). Receiving of the locking element 21 in the receiving slot 22 reduces or prevents a movement clearance of the holding component 9 relative to the housing 5 at least in the axial direction and in the radial direction.

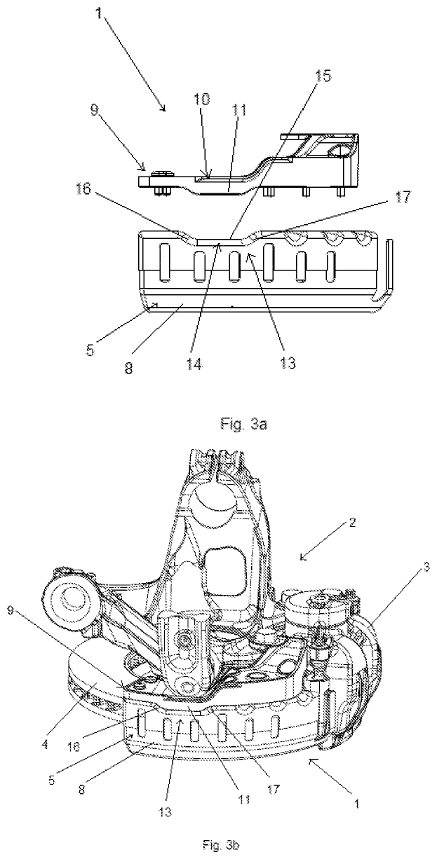

FIGS. 3a and 3b show a third embodiment of the brake dust particle filter assembly 1 according to the invention. FIG. 3a does not show the brake dust particle filter assembly 1 in the installed position. FIG. 3b shows the brake dust particle assembly 1 in the installed position in the disc brake assembly 2. The third embodiment corresponds basically to the first embodiment of FIGS. 1a and 1b. However, the third embodiment of the brake dust particle filter assembly 1 does not comprise the groove inner end face 18 facing inwardly in radial direction. The groove 14 is not closed here but embodied continuous.

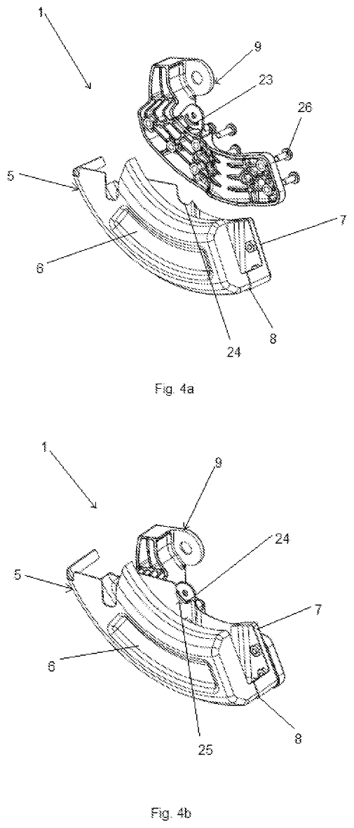

FIGS. 4a and 4b show a fourth embodiment of the brake dust particle filter assembly 1 according to the invention. FIG. 4a does not show the brake dust particle filter assembly 1 in the installed position. FIG. 4b shows the brake dust particle filter assembly 1 in the installed position. In the fourth embodiment, the male connection geometry 10 is embodied as a ring segment geometry 23 which projects in axial direction and extends in circumferential direction. The corresponding female connection geometry 13 is designed as a ring segment receptacle 24. The ring segment receptacle 24 is configured by means of a ring segment-shaped section 25 of a radially inwardly facing inner end face of the female connection geometry 13 such that in the installed position the holding component 9 and the housing 5 are movable relative to each other in circumferential direction.

The holding component 9 and the housing 5 are thus fixed stationarily relative to each other in their radial position in the installed position, but not in their angular position in circumferential direction. Thus, a “post correction” of the angular position of the holding component 9 relative to the housing 5 in the installed position is possible initially. The brake dust particle filter can thus be rotated finally into its installed position. In this installed position, it is then fixed stationarily, for example, by means of screws 26.

What is claimed is:

1. A brake dust particle filter assembly for catching brake dust particles produced upon actuation of a disc brake assembly, the brake dust particle filter assembly comprising:
a brake dust particle filter comprising a ring segment-shaped housing configured to receive at least partially a brake disc of the disc brake assembly;
the ring segment-shaped housing comprising two housing sidewalls axially spaced apart relative to each other in an axial direction of the ring segment-shaped housing and further comprising a housing circumferential wall extending at least in sections thereof in a circumferential direction of the ring segment-shaped housing between the two housing sidewalls;
a filter element arranged in the ring segment-shaped housing;
a holding component configured to hold the brake dust particle filter in an installed position that is stationary relative to the disc brake assembly,
the holding component and the ring segment-shaped housing configured to be directly fixed relative to each other, at least in relation to an angular position of the holding component and the ring segment-shaped housing in the circumferential direction relative to each other and/or a radial position of the holding component and the ring segment-shaped housing relative to each other in a radial direction relative to the axial direction, by a mutual engagement in the installed position;
wherein the mutual engagement is realized by a form-fit engagement of a male connection geometry with a corresponding female connection geometry;
wherein the male connection geometry is provided at the holding component and the female connection geometry is provided at the ring segment-shaped housing, or the male connection geometry is provided at the ring segment-shaped housing and the female connection geometry is provided at the holding element.

2. The brake dust particle filter assembly according to claim 1, wherein the male connection geometry or the female connection geometry is provided at one of the two housing sidewalls.

3. The brake dust particle filter assembly according to claim 3, wherein
the male connection geometry or the female connection geometry extends from said one of the two housing sidewalls at least in an axial direction on a side of said one of the two housing sidewalls facing away from the filter element.

4. The brake dust particle filter assembly according to claim 1, wherein the female connection geometry comprises a groove, wherein the groove comprises a groove base extending in a radial direction and further comprises two groove flanks oppositely positioned in relation to each other in the circumferential direction.

5. The brake dust particle filter assembly according to claim 4, wherein the two groove flanks gradually rise in the circumferential direction away from the groove base.

6. The brake dust particle filter assembly according to claim 4, wherein the groove is closed at a groove inner end face facing inwardly in the radial direction, wherein an outer end face of the male connection geometry facing outwardly in the radial direction contacts the groove inner end face in the installed position.

7. The brake dust particle filter assembly according to claim 6, wherein
the groove inner end face is formed by the female connection geometry.

8. The brake dust particle filter assembly according to claim 4, wherein the groove base comprises a locking element projecting outwardly in the axial direction, wherein the locking element in the installed position is locked with an inner end face of the male connection geometry, wherein the inner end face is facing inwardly in the radial direction.

9. The brake dust particle filter assembly according to claim 4, wherein the female connection geometry comprises at least one locking element projecting across the groove base, wherein the at least one locking element, in the installed position, engages a plug section of the male connection geometry arranged in the groove.

10. The brake dust particle filter assembly according to claim 1, wherein the male connection geometry comprises at least one ring segment geometry projecting in the axial direction and extending in the circumferential direction, wherein the female connection geometry comprises a corresponding ring segment receptacle configured to receive the at least one ring segment geometry, wherein the at least one ring segment geometry and the corresponding ring segment receptacle engage each other in the installed position to produce the mutual engagement.

11. The brake dust particle filter assembly according to claim 10, wherein the ring segment receptacle is a ring segment-shaped section of a radially inwardly oriented inner end face of the female connection geometry and the ring segment-shaped section is configured to permit, in the installed position, a movement of the holding component and the ring segment-shaped housing relative to each other in the circumferential direction.

12. The brake dust particle filter assembly according to claim 10, wherein a circumferential extension of the male connection geometry is variable in the radial direction and a circumferential extension of the female connection geometry is variable in the radial direction.

13. The brake dust particle filter assembly according to claim 12, wherein the circumferential extension of the male connection geometry and the circumferential extension of the female connection geometry decrease outwardly in the radial direction.

14. A disc brake assembly with a brake disc, a brake caliper, and a brake dust particle filter assembly according to claim 1.

15. A vehicle comprising:
a disc brake assembly comprising a brake disc, a brake caliper, and a brake dust particle filter assembly according to claim 1;
wherein the holding component of the brake dust particle filter assembly is fastened stationarily at a vehicle component of the vehicle in relation to the brake caliper of the brake disc assembly.

16. The vehicle according to claim 15, wherein the vehicle component is a steering knuckle or a brake caliper holder.
